(19) United States
(12) Patent Application Publication
(10) Pub. No.: US 2014/0351228 A1
(43) Pub. Date: Nov. 27, 2014

(54) DIALOG SYSTEM, REDUNDANT MESSAGE REMOVAL METHOD AND REDUNDANT MESSAGE REMOVAL PROGRAM

(71) Applicant: Kosuke Yamamoto, Koto-ku (JP)

(72) Inventor: Kosuke Yamamoto, Koto-ku (JP)

(21) Appl. No.: 14/360,726

(22) PCT Filed: Aug. 14, 2012
(86) PCT No.: PCT/JP2012/005150

§ 371 Date: May 27, 2014

(30) Foreign Application Priority Data
Nov. 28, 2011 (JP) 2011-258843

(51) Int. Cl. G06F 17/30

(52) U.S. Cl. CPC G06F 17/30489; G06F 17/3053
USPC 707/692; 707/723

(57) ABSTRACT

There are provided an answer evaluation means 501 that finds an answer content indicating how much an expression which would be an answer for a query is contained in a series of user's comments for the query contained in a set of queries which are response message candidate for a user's comment as characters string information indicating user's comment contents and which are character string information in a question form, and a query ranking means 502 that ranks each query in ascending order of answer content based on the answer content of each query in a user's comment found by the answer evaluation means 501.

### TECHNICAL FIELD

The present invention relates to a dialog system for having a dialog with a user by outputting some response messages to a user's comment, and a redundant message removal method and program for the dialog system.

### BACKGROUND ART

In recent years, dialog systems are widely used in order to automatically reply answers or confirm concerns to a user's question thereby to reduce cost for the user.

For example, dialog systems utilized in call centers include a QA automated support system for automatically answering clients' complaints or questions in order to reduce cost for operators. Additionally, dialog systems are utilized for a dialog care system for responding a message indicating advice or sympathy to a user's problem based on specialized knowledge accumulated in databases in order to reduce cost for medical doctors.

Some dialog systems employ a method for outputting a response message in a question form to user-input contents in order to continue a dialog until a solution which a user is satisfied with or information which the systems desire is all acquired.

In the dialog systems employing such a method, an important point for smoothly having a dialog is how to return an appropriate question to user-input contents. For example, in a series of dialogs between a user and a dialog system, if a query whose answer would be what the user has already commented is output as a response message, the user has to input similar contents as an answer again. Consequently, there have arisen the problems that useless work is imposed and that a feeling of dialog cannot be obtained.

An exemplary technique for smoothly having a dialog with a dialog system is described in PTL 1, for example. A speech dialog system described in PTL 1 is such that when a word to be searched is input by a user, information on search results for the word to be searched is output. The speech dialog system described in PTL 1 is not a dialog system in which a user is caused to sequentially input necessary information items, but a system in which a word to be searched, which has a wide range of vocabularies, is first input and then information on other necessary input items is estimated based on the resultant word to be searched. If information on additional input items can be estimated from one input item, redundant questions for the estimated input items are dispensable.

### CITATION LIST

### Patent Literature

PTL 1: JP 2001-100787 A

### SUMMARY OF INVENTION

### Technical Problem

A problem is that in a dialog system, the system can output a query whose answer would be what a user has already commented in a series of dialogs.

For example, with the method described in PTL 1, a user who requests the phone number of “Fujisawa City Office” is caused to first input “Fujisawa City Office” as a word to be searched, and thus “Fujisawa City” as a city name and “City Office” as a business category are estimated from the word to be searched, and the questions therefor can be omitted.

However, the method described in PTL 1 is directed for removing redundant questions by use of an associated relationship in predetermined input items like a word to be searched. That is, the method described in PTL 1 is not directed for determining whether contents which would be an answer to a question made by the system are contained in what the user has already commented, thereby removing such redundant questions.

Therefore, the method described in PTL 1 can be applied to only a dialog system in which necessary input items and the like are previously determined and the input items are associated with each other. For example, with a dialog system for accepting user's input in a free form like the QA automated support system or dialog care system described above, partial character strings as characteristic words are enormous, and “input items” may not be previously determined or may change depending on dialog contents. Further, a characteristic word may indicate different meanings in an actual dialog, and is difficult to associate with input items. In this way, with the dialog system for accepting user's input in a free form, input items corresponding to characteristic words are very difficult to properly register in advance for all the characteristic words.

To “properly” register characteristic words and input items means to register so accurately and limitedly that redundant questions can be omitted from all possible questions. If a correspondence between a characteristic word and an input item is not appropriate, accuracy of estimation result cannot be enhanced, and thus questions for the input items cannot be finally omitted.

That is, the method described in PTL 1 prepares a partial character string-based database thereby to enable the characteristic amount corresponding to a predetermined query to be set. However, with the method for previously preparing a partial character string-based database and the like and setting the characteristic amount per query, the characteristic amounts corresponding to many queries are difficult to exhaustively select.

It is therefore an exemplary object of the present invention to provide a dialog system capable of preventing a system from outputting a query whose answer would be what a user has already commented in a dialog system in which a variety of inputs are made, a redundant message removal method and program for the dialog system.

### Solution to Problem

A dialog system according to the present invention includes an answer evaluation means that finds an answer content indicating how much an expression which would be an answer for a query is contained in a series of user's comments for each query contained in a set of queries which are response message candidates for a user's comment as character string information indicating user's comment contents and which are character string information in a question form, and a query ranking means that ranks each query in ascending order of answer content based on an answer content of each query in a user's comment found by the answer evaluation means.

A redundant message removal method according to the present invention includes a step of finding an answer content indicating how much an expression which would be an answer for a query is contained in a series of user's comments for each query contained in a set of queries which are response message candidates for a user's comment as character string information indicating user's comment contents and which are character string information in a question form, and a step of, when the found answer content of the query in the user's comment is higher than a predetermined threshold, removing the query as a response message of redundant question from the response message candidates.

A redundant message removal program according to the present invention is characterized by causing a computer to perform processing of finding an answer content indicating how much an expression which would be an answer for a query is contained in a series of user's comments for each query contained in a set of queries which are response message candidates for a user's comment as character string information indicating user's comment contents and which are character string information in a question form, and processing of, when the found answer content of the query in the user's comment is higher than a predetermined threshold, removing the query as a response message of redundant question from the response message candidates.

### Advantageous Effects of Invention

According to the present invention, it is possible to prevent a system from outputting a query whose answer would be what a user has already commented in a dialog system in which a variety of inputs are made.

### BRIEF DESCRIPTION OF DRAWINGS

FIG. 1 It depicts a block diagram illustrating an exemplary structure of a dialog system according to the present invention.

FIG. 2 It depicts a block diagram illustrating an exemplary structure of a redundant query removal unit 14.

FIG. 3 It depicts an explanatory diagram illustrating exemplary dialog knowledge stored in a dialog knowledge database 22.

FIG. 4 It depicts a flowchart illustrating exemplary operation of a dialog system according to an exemplary embodiment.

FIG. 5 It depicts a flowchart illustrating an exemplary processing flow of redundant query removal processing by the redundant query removal unit 14.

FIG. 6 It depicts a flowchart illustrating an exemplary processing flow of answer content calculation processing by an answer evaluation unit 141.

FIG. 7(a) It depicts an explanatory diagram illustrating an exemplary user's comment input into the redundant query removal unit 14.

FIG. 7(b) It depicts an explanatory diagram illustrating an exemplary set of queries input into the redundant query removal unit 14.

FIG. 8 It depicts an explanatory diagram illustrating an exemplary analysis result of a morphological analysis made on ID1 query, and exemplary extracted query characteristic amount.

FIG. 9 It depicts an explanatory diagram illustrating an exemplary analysis result of a morphological analysis made on ID2 query, and an exemplary extracted query characteristic amount.

FIG. 10 It depicts an explanatory diagram illustrating an exemplary analysis result of a morphological analysis made on ID3 query, and an exemplary extracted query characteristic amount.

FIG. 11 It depicts an explanatory diagram illustrating an exemplary analysis result of a morphological analysis made on ID4 query, and exemplary extracted query characteristic amount.

FIG. 12 It depicts an explanatory diagram illustrating an exemplary analysis result of a morphological analysis made on ID5 query, and exemplary extracted query characteristic amount.

FIG. 13 It depicts an explanatory diagram illustrating exemplary extraction results of the query characteristic amounts and their exemplary retaining of the respective queries.

FIG. 14(a) It depicts an explanatory diagram illustrating exemplary analysis results of a morphological analysis made on a user's comment.

FIG. 14(b) It depicts an explanatory diagram illustrating exemplary extracted user's comment characteristic amount.

FIG. 15 It depicts an explanatory diagram illustrating calculation results of characteristic amount contents of the respective queries.

FIG. 16 It depicts an explanatory diagram illustrating calculation results of answer contents of the respective questions when word importance is added.

FIG. 17 It depicts an explanatory diagram illustrating an exemplary conversion table.

FIG. 18 It depicts an explanatory diagram illustrating exemplary conversions of the queries.

FIG. 19 It depicts an explanatory diagram illustrating exemplary analysis results of a morphological analysis made on a user's comment and exemplary attribute value estimations.

FIG. 20(a) It depicts an explanatory diagram illustrating exemplary calculations of question possibilities of the respective queries.

FIG. 20(b) It depicts an explanatory diagram illustrating exemplary ranked queries based on the question possibilities.

FIG. 21(a) It depicts an explanatory diagram illustrating other exemplary calculations of question possibilities.

FIG. 21(b) It depicts an explanatory diagram illustrating other exemplary ranked queries based on the question possibilities.

FIG. 22 It depicts a block diagram illustrating other exemplary structure of the redundant query removal unit 14.

FIG. 23 It depicts a block diagram illustrating an outline of the present invention.

### DESCRIPTION OF EMBODIMENTS

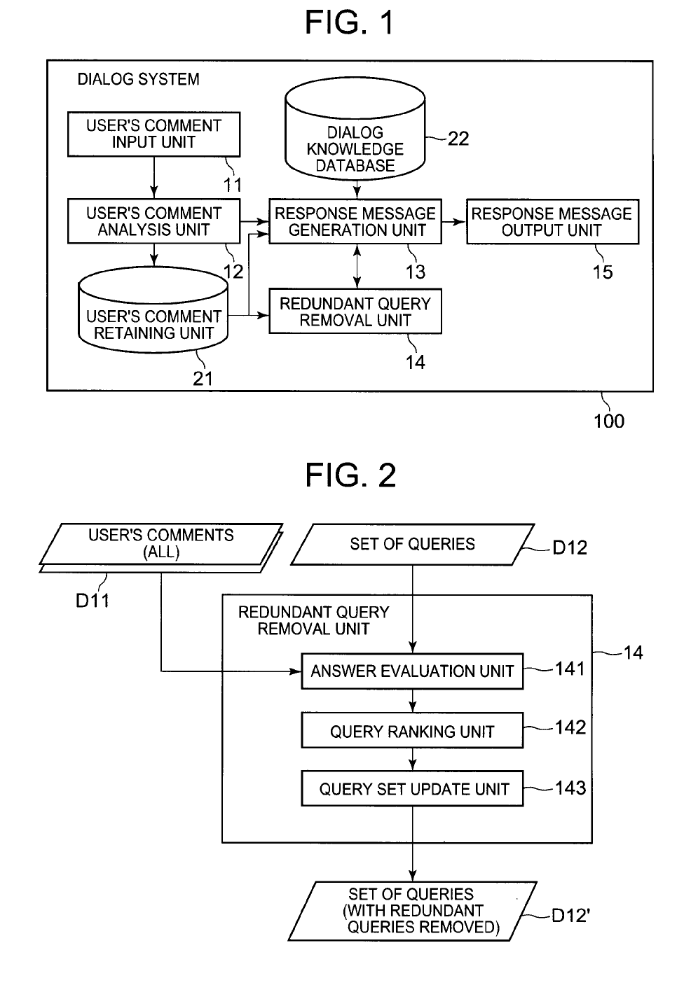

FIG. 1 is a block diagram illustrating an exemplary structure of a dialog system according to the present invention. The dialog system 100 illustrated in FIG. 1 is directed for analyzing a user-input text and automatically generating or selecting and outputting a corresponding message. The dialog system 100 illustrated in FIG. 1 includes a user's comment input unit 11, a user's comment analysis unit 12, a response message generation unit 13, a redundant query removal unit 14, a response message output unit 15, a user's comment retaining unit 21, and a dialog knowledge database 22.

FIG. 2 is a block diagram illustrating an exemplary structure of the redundant query removal unit 14. The redundant query removal unit 14 is a processing unit for outputting a set of queries D12′ with redundant queries removed assuming a series of user's comments D11 and a set of queries D12 as inputs. As illustrated in FIG. 2, the redundant query removal unit 14 includes an answer evaluation unit 141, a query ranking unit 142, and a query set update unit 143.

The user's comment input unit 11 inputs user's comments therein. More specifically, the user's comment input unit 11 accepts an input user's comment, and passes it to the later user's comment analysis unit 12. The user's comment input unit 11 may hold the accepted user's comment in the user's comment retaining unit 21. A user's comment is character string information indicating comment contents input by the user into the system. When the user makes speech input, the user's comment input unit 11 may convert the speech into a text form. The user's comment input unit 11 is realized by an information input device such as keyboard. When a user's comment is input via a communication line, the user's comment input unit 11 is realized by a network interface and its control unit.

The user's comment analysis unit 12 performs, on an input user's comment, analysis processing such as syntax analysis or semantic analysis for recognizing a comment form and comment contents. The user's comment analysis unit 12 may hold information acquired as a result of the analysis in the user's comment retaining unit 21 instead of or in addition to user's comment original.

The user's comment analysis unit 12 makes a morphological analysis or syntax analysis of each sentence contained in a user's comment, for example, thereby to extract words contained in each sentence, and to specify parts of speech and a modification relationship of the sentence. The user's comment analysis unit 12 performs processing of giving a meaning tag indicating information on word meaning or syntax environment to a characteristic word among the extracted words. Thereby, the user's comment is converted into a data form by which the system can understand the comment contents. The meaning of a word given as a meaning tag may indicate a classification item on an attribute of the word used in dialog knowledge described later.

For example, when the user's comment “KOUENDESAIFUWONAKUSHITA” (I lost my wallet in the park.) is input, syntax information “KOUEN/DE/SAIFU/WO/NAKUSU/TA” is acquired by a morphological analysis. The user's comment analysis unit 12 may give meaning tags indicating a vocabulary classification item of a word to predetermined words with parts of speech such as noun based on the thus-acquired syntax information. The user's comment analysis unit 12 may utilize a word dictionary (not illustrated) for giving a meaning tag. The user's comment analysis unit 12 gives a meaning tag indicating [place] assuming that the word “KOUEN” (park) indicates a word indicating [place] among the vocabulary classification items. The user's comment analysis unit 12 gives a meaning tag indicating [belongings] assuming that the word “SAIFU” (wallet) indicates a word indicating [belongings] among the vocabulary classification items.

The user's comment retaining unit 21 holds a series of user's comments. The user's comment retaining unit 21 may be a database which stores all of input users' comments since the start of dialog per user, for example.

The response message generation unit 13 generates response message candidates for an input user's comment based on an analysis result by the user's comment analysis unit 12 and the dialog knowledge stored in the dialog knowledge database 22. The response message generation unit 13 outputs a set of queries made of response messages in a query form among the generated response message candidates to the redundant query removal unit 14 described later to remove redundant queries. Then, after the redundant query removal unit 14 removes redundant queries, the response message generation unit 13 determines a response message to be output from among the final response message candidates.

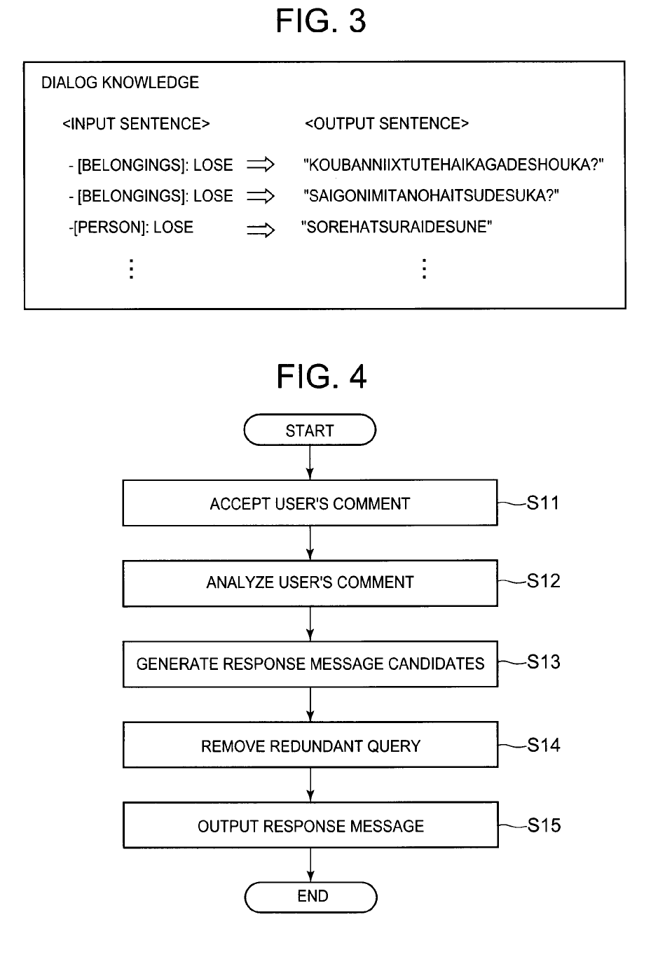

The dialog knowledge database 22 is a database for previously storing dialog knowledge therein. The dialog knowledge is previously-accumulated information on dialogs for establishing a dialog. The dialog knowledge may be information in which typical input sentence expressions are associated with output sentences, for example. At this time, the input sentence expressions or output sentences may be in a template form by use of previously-defined vocabulary classification items. FIG. 3 is an explanatory diagram illustrating exemplary dialog knowledge stored in the dialog knowledge database 22. The example illustrated in FIG. 3 indicates that two response messages “KOUBANNIIXTUTEHAIKAGADESHOU?” (Why not ask at a police box?) and “SAIGONIMITANOHAITSUDESUKA?” (When did you see it last?) are registered as dialog knowledge for the sentence in which the word “NAKUSU” (lose) follows the word with the meaning tag [belongings]. Further, the example illustrated in FIG. 3 indicates that the response message “SOREHATSURAIDESUNE” (It's terrible.) is registered for the sentence in which the word “NAKUSU” (lose) follows the word with the meaning tag [person]. Additionally, the response messages such as “DONNA [belongings] DESUKA?” (What kind of [belongings] is it?), “IEWOSAGASHITEMITEHAIKAGADESHOUKA?” (Why not find it in the house?) and “ITSUMOHADOKONIARUNODESUKA?” (Where do you usually put it?) may be possible for a sentence in which the word “NAKUSU” (lose) follows the word with the meaning tag [belongings]. The brackets “[ ]” in FIG. 3 indicate a classification item name used for a meaning tag given to a word. When “[ ]” is used in a response message, the part is converted into a word which is of a classification item name indicated within [ ] and is used in the input sentence, and is output. For example, the above “DONNA [belongings] DESUKA?” (What kind of [belongings] is it?) is converted into “DONNASAIFUDESUKA?” (What kind of wallet is it?) and is output.

The redundant query removal unit 14 inputs a series of user's comments and a set of queries. The redundant query removal unit 14 determines whether a query whose answer would be what the user has already commented is present in the input set of queries, and if any, removes the query.

For a series of user's comments, a user's comment to be specifically input in which range is not particularly limited. A series of user's comments may be all the user's comments input after the dialog is started, for example. When an obvious topic change is detected in the middle, a series of user's comments may be limited to the user's comments input after the detection. A series of user's comments may be delimited simply based on the number of dialogs or a dialog time, such as user's comments except the last comment or users' comments input in the last one hour, or may be only one now-input user's comment.

The answer evaluation unit 141 finds an answer content of each query contained in the input set of queries in a series of user's comments. The answer evaluation unit 141 finds confidence between a query and each sentence contained in a series of user's comments by use of an evaluation model for outputting how much two arbitrary sentences are in a question/answer relationship as quantitative confidence. The answer evaluation unit 141 may assume the total found confidence as an answer content of the queries in the user's comment. In the present exemplary embodiment, the answer content is assumed to take a value of 0 to 1, confidence when a user's comment and a query are in a question/answer relationship is assumed as high at 1, and confidence is assumed as low at 0. When a plurality of user's comments are made, the answer evaluation unit 141 may find an answer content for each comment, and the highest answer content may be assumed as an answer content of the query in a series of user's comments.

The evaluation model used in the answer evaluation unit 141 may be an evaluation model for evaluating an answer for a question, for example. The evaluation model may be an evaluation model constructed with machine learning by use of text information of a site in which many questions/answers have been already made like a QA site, for example.

The evaluation model is constructed with machine learning of a relationship of question/answer pair by features such as a question type, and character string, part of speech, meaning tag and modification destination of a word grasped as an answer part, or character string, part of speech and meaning tag of a modification source word.

By way of a specific example, there is assumed a pair of information on the question “FUJISANNOTAKASAHANANME-TORUDESUKA?” (What is the height of Mt. Fuji?) and the answer “3776mDESU” (3776 meters high.) When a morphological analysis, syntax analysis, meaning tag giving and the like are made on the question, the question can be given a meaning tag [Name of mountain] for the word “FUJISAN” (Mt. Fuji), and a meaning tag [unit of length] for the word “TAKASA” (height) and the word “ME-TOEU” (meters), and the like. The answer sentence can be given a meaning tag [number] for “3776” and a meaning tag [unit of length] for “m.” Many pairs of information similar thereto are present, and machine learning is performed with features such as character string, part of speech and meaning tag so that a statistic model can be constructed in which an answer in combination of [number]+[unit of length] is apt to be made for a question on [height of mountain].

When the same word is present in both a query and a user's comment, for example, the answer evaluation unit 141 may calculate an answer content by use of a calculation method for increasing an answer content. With such a method, an answer content can be found without information as previous knowledge. In this case, the answer evaluation unit 141 may assume the above calculation logic as an evaluation model for outputting confidence based on similarity between the query and the user's comment, and may use it for calculating an answer content.

The query ranking unit 142 ranks each query contained in a set of queries in ascending order of answer content. Specifically, the query ranking unit 142 assumes a question with a low answer content as a question for asking what the user has not commented, and increases its priority. The query ranking unit 142 may find a question possibility for each query instead of priority. For example, (1—answer content) may be assumed as a question possibility for each query. The question possibility indicates that a question with a higher value is more suitable for a response message. Each query contained in a set of queries may be given importance of question. In this case, the query ranking unit 142 may find a question possibility by a value obtained by subtracting an answer content from importance given to each query. Further, the query ranking unit 142 may select a query suitable for the user's comment from among the queries contained in a set of queries based on the found ranking or question possibility of each query. Furthermore, the query ranking unit 142 may determine whether each query is a redundant query based on the found ranking or question possibility of each query.

A question possibility calculation result or a suitable query based on it is selected as a result of the ranking by the query ranking unit 142 so that the query set update unit 143 updates and outputs a set of queries based on a determination result as to whether the query is redundant.

The query set update unit 143 may add and output information on ranking or question possibility to each query, or may delete and output a redundant query from a set of queries, or may delete and output the queries from the set of queries except one query selected as a suitable query.

The response message output unit 15 outputs a response message generated or selected by the response message generation unit 13.

In the present exemplary embodiment, the user's comment analysis unit 12, the response message generation unit 13, the redundant query removal unit 14 and the response message output unit 15 are realized by an information processing apparatus such as CPU operating according to a program. The response message output unit 15 may be realized by an information processing apparatus and an information output device such as display. The response message output unit 15 may be realized by an information processing apparatus, a network interface and its control unit when outputting a response message via a communication line. The user's comment retaining unit 21 and the dialog knowledge database 22 are realized by a storage device, for example.

In the present exemplary embodiment, the constituents except the redundant query removal unit 14 may be similar to a general dialog system which analyzes a user-input text and automatically generates or selects and outputs a corresponding message. That is, the respective processing unit except the redundant query removal unit 14 may have the functions provided in a general dialog system.

The operation of the present exemplary embodiment will be described below. FIG. 4 is a flowchart illustrating exemplary operation of the dialog system according to the present exemplary embodiment. As illustrated in FIG. 4, the user's comment input unit 11 first accepts a user's comment (step S11). When accepting a user's comment, the user's comment input unit 11 records it in the user's comment retaining unit 21 and passes it to the user's comment analysis unit 12.

The user's comment analysis unit 12 analyzes the input user's comment and converts it into a data form by which the system can understand the comment contents (step S12). Herein, the user's comment analysis unit 12 performs processing of giving a meaning tag to a characteristic word based on a morphological analysis of the user's comment or the analyzed syntax.

Then, the response message generation unit 13 generates response message candidates for the input user's comment by use of the dialog knowledge stored in the dialog knowledge database 22 based on the analysis result by the user's comment analysis unit 12 (step S13). The response message generation unit 13 outputs a set of queries made of response messages in a query form among the generated response message candidates to the redundant query removal unit 14. At this time, the response message generation unit 13 outputs the user's comment used for determination together.

When being input with the user's comment used for determination and the set of queries, the redundant query removal unit 14 performs redundant query removal processing on the input set of queries (step S14). The redundant query removal processing will be described later.

When the redundant query removal processing is completed, the response message generation unit 13 determines a response message to be actually output from among the response message candidates left after the redundant query removal processing. Then, the response message output unit 15 outputs the determined response message (step S15).

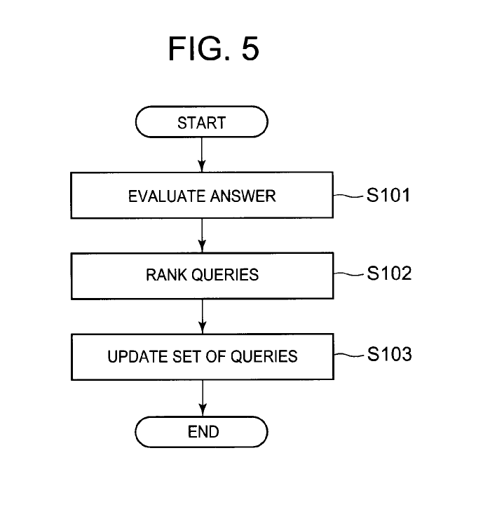

The redundant query removal processing by the redundant query removal unit 14 will be described below. FIG. 5 is a flowchart illustrating an exemplary processing flow of the redundant query removal processing by the redundant query removal unit 14. As illustrated in FIG. 5, when the user's comment used for determination and the set of queries are input into the redundant query removal unit 14, the answer evaluation unit 141 first finds an answer content of each query contained in the input set of queries in the input user's comment, and evaluates an answer for the user's comment (step S101).

When the answer evaluation unit 141 finds an answer content of each query, the query ranking unit 142 ranks each query based on the answer content of each query (step S102).

At last, the query set update unit 143 updates and outputs a set of queries based on a ranking result by the query ranking unit 142 (step S103).

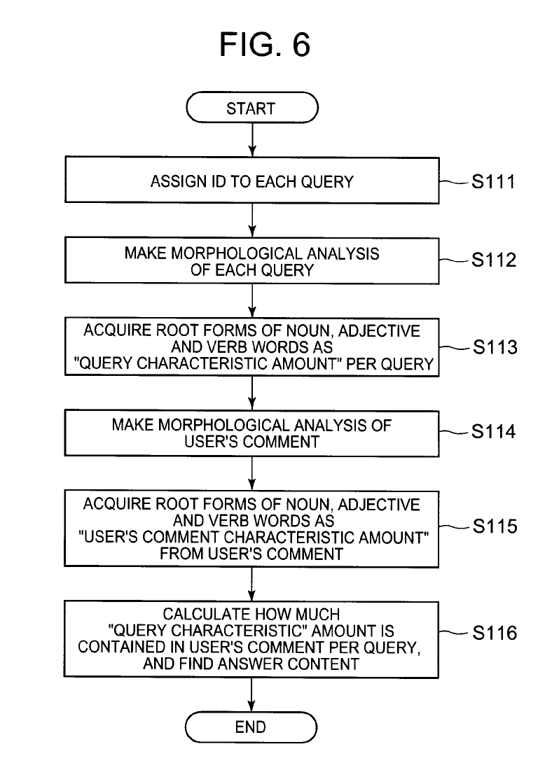

The answer content calculation method by the answer evaluation unit 141 will be described below in detail. FIG. 6 is a flowchart illustrating an exemplary processing flow of the answer content calculation processing by the answer evaluation unit 141. The example illustrated in FIG. 6 is an example in which an answer content is calculated without information as previous knowledge. The answer evaluation unit 141 first assigns an ID to each query (step S111). After assigning an ID, the answer evaluation unit 141 makes a morphological analysis of each query, and holds the result in association with the ID (step S111).

Then, the answer evaluation unit 141 assumes the noun, adjective and verb words as the characteristic words per query, and acquires the root forms of the words as the query characteristic amounts (step S112). The answer evaluation unit 141 may acquire the query characteristic amounts in a vector form of the information on the root forms of the words from the database registering the morphological results therein, for example. The vector form indicates that data arrangements are held, and in this case, information on the root forms of words is assumed as an arrangement of characteristic amounts.

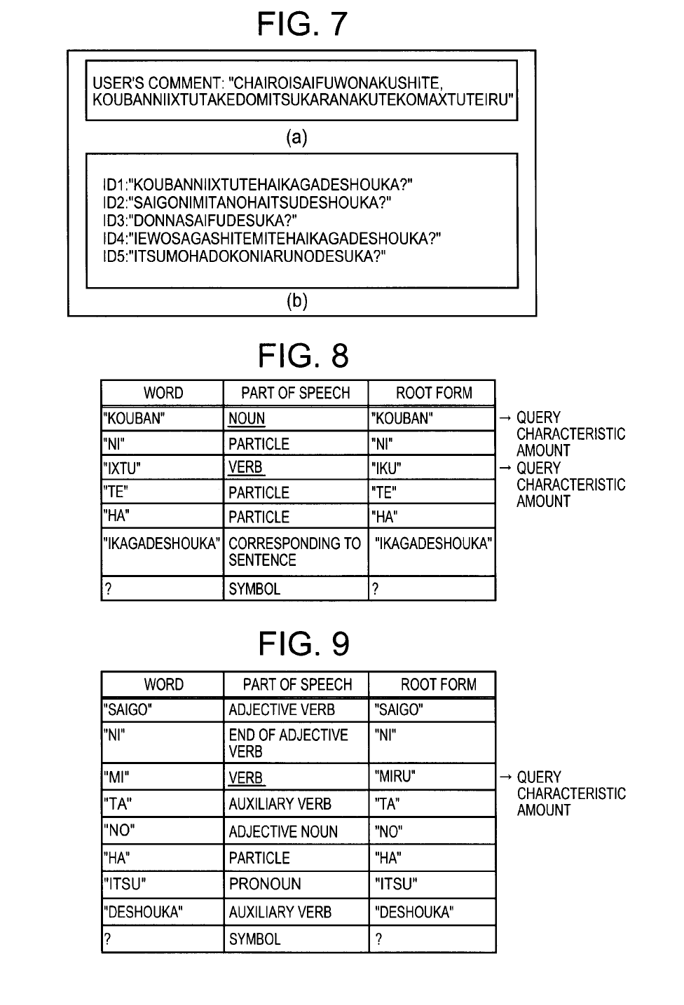

FIG. 7(a) is an explanatory diagram illustrating an exemplary user's comment input into the redundant query removal unit 14. FIG. 7(b) is an explanatory diagram illustrating an exemplary set of queries input into the redundant query removal unit 14, and exemplary assigned IDs. In the following, an explanation will be made assuming that the user's comment “CHAIROISAIFUWONAKUSHITE,KOUBANNIIXTUTAKEDOMITSUKARANAKUTEK OMAXTUTEIRU” (I lost my brown wallet and asked at a police box, but I could not find it. So, I'm in trouble.) and a set of five queries are input. The five queries include ID1 “KOUBANNIIXTUTEHAIKAGADESHOU?” (Why not ask at a police box?), ID2 “SAIGONIMITANOHAITSUDESHOUKA?” (When did you see it last?), ID3 “DONNASAIFUDESUKA?” (What kind of wallet is it?), ID4 “IEWOSAGASHITEMITEHAIKAGADESHOUKA?” (Why not find it in the house?) and ID5 “ITSUMOHADOKONIARUNODESUKA?” (Where do you usually put it?.)

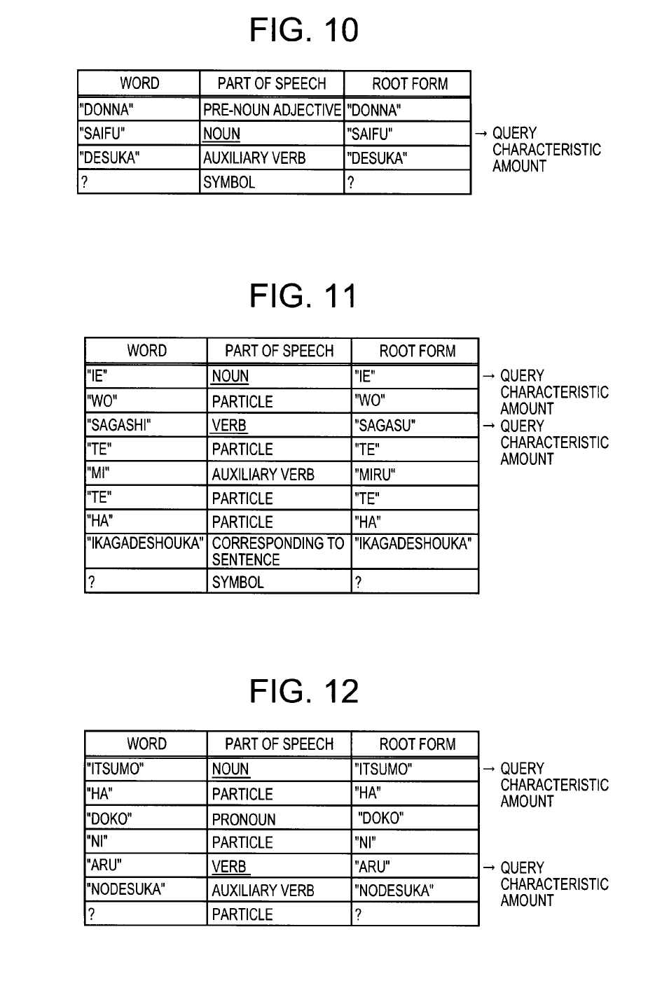

FIGS. 8 to 12 are the explanatory diagrams illustrating exemplary analysis results of a morphological analysis made on the respective queries, and exemplary extracted query characteristic amounts. The contents illustrated in FIG. 8 are an example of the ID1 query. The contents illustrated in FIG. 9 are an example of the ID2 query. The contents illustrated in FIG. 10 are an example of the ID3 query. The contents illustrated in FIG. 11 are an example of the ID4 query. The contents illustrated in FIG. 12 are an example of the ID5 query.

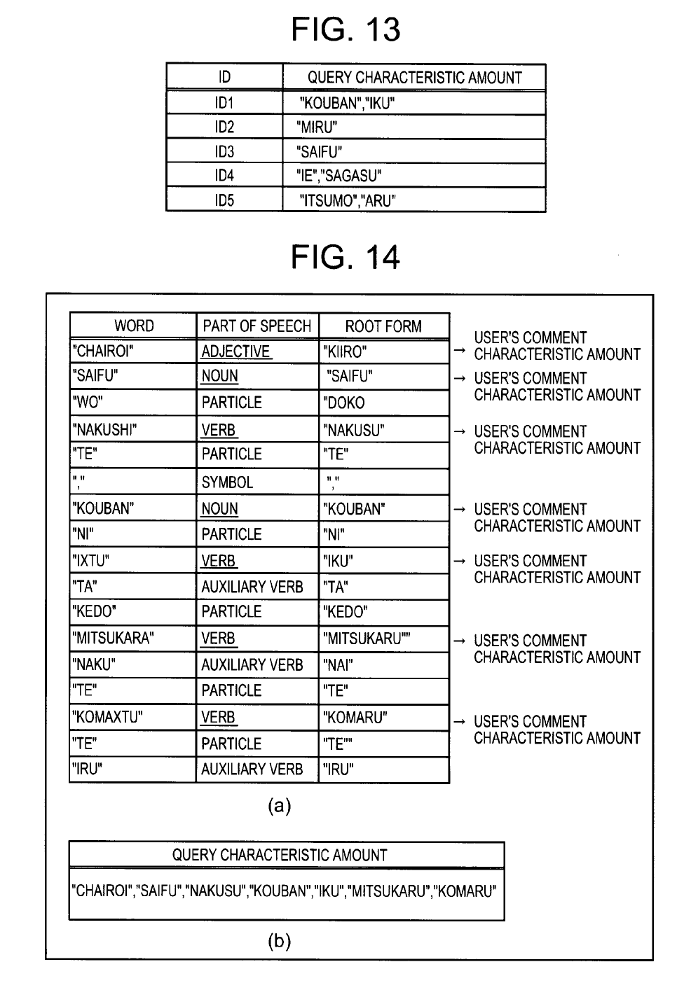

FIG. 13 is an explanatory diagram illustrating exemplary extraction results of the query characteristic amounts from the respective queries, and exemplary their retaining. As illustrated in FIG. 13, the query characteristic amount extracted from the ID1 query is {KOUBAN, IKU}(police box, ask). The query characteristic amount extracted from the ID2 query is {MIRU}(see). The query characteristic amount extracted from the ID3 query is {SAIFU}(wallet). The query characteristic amount extracted from the ID4 query is {IE, SAGASU} (house, find). The query characteristic amount extracted from the ID5 query is {ITSUMO, ARU} (usually, put).

Then, the answer evaluation unit 141 performs similar processing to steps S112 and S113 on the user's comment, and acquires the user's comment characteristic amount (steps S114 and S115).

FIG. 14(a) is an explanatory diagram illustrating exemplary analysis results of a morphological analysis made on the user's comment and exemplary extracted user's comment characteristic amount. FIG. 14(b) is an explanatory diagram illustrating an exemplary result of extracted user's comment characteristic amount from the user's comment, and exemplary their retaining. As illustrated in FIGS. 14(a) and (b), the user's comment characteristic amount {“CHAIROI”,“SAIFU”,“NAKUSU”,“KOUBAN”,“IKU”,“MITSUKARU”,“KOM ARU”} (brown, wallet, lost, police box, ask, find, in trouble) is acquired from the user's comment.

When completely acquiring the query characteristic amount of each query and the user's comment characteristic amount, the answer evaluation unit 141 calculates a characteristic amount content quantitatively indicating how much the query characteristic amount of each query is contained in the user's comment characteristic amount, and assumes it as the answer content of each query (step S116).

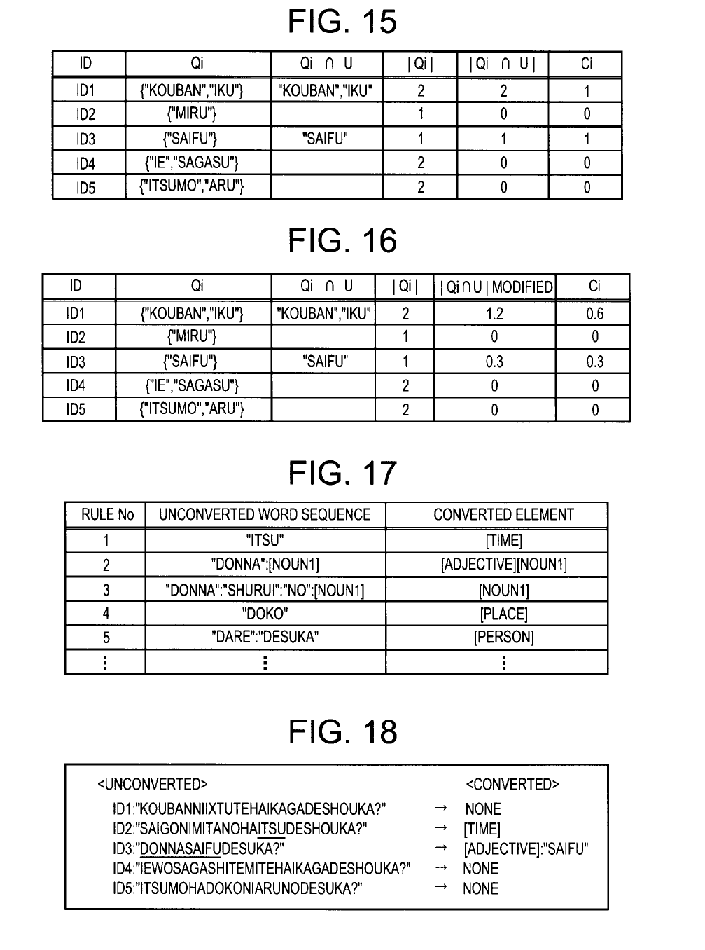

FIG. 15 is an explanatory diagram illustrating the calculation results of the characteristic amount contents of the respective queries. In FIG. 15, the query characteristic amount of an i-th query is indicated with set Qi, and the user's comment characteristic amount is indicated with set U. In the example illustrated in FIG. 15, the characteristic amount content Ci of an i-th query is found in the following Equation (1). ∥ indicates the number of elements in a set. The symbol ∩ indicates a common set.

Ci=|Qi∩U|/|Qi| Equation (1)

In the example illustrated in FIG. 15, the characteristic amount content C1=1 of the ID1 query, the characteristic amount content C2=0 of the ID2 query, the characteristic amount content C3=1 of the ID3 query, the characteristic amount content C4=0 of the ID4 query, and the characteristic amount content C5=0 of the ID5 query are found.

With another method, the answer evaluation unit 141 may give word importance to each word contained in the set of question characteristic amounts U of the user's comment, and may find a characteristic amount content added with the word importance. When in use of the word importance, for example, the answer evaluation unit 141 is assumed to previously hold importance reference information in which a word and importance are recorded in an associated manner. With the importance reference information, importance for a word can be referred to with the word as a key.

The answer evaluation unit 141 may find a frequency of a word in an arbitrary set of documents, and may use, as the importance reference information, word importance calculated as being higher at a lower frequency. The answer evaluation unit 141 may acquire the importance reference information in this way.

It is herein assumed that each element (or each word) in the set Qi as the query characteristic amount of an i-th query is q_ij, each element (or each word) in the set U as the user's comment characteristic amount is u_k, and word importance of each word u_k contained in the user's comment characteristic amount is w_k. j and k are the indexes indicating each element in the set Qi and each element in the set U, respectively. When in use of the word importance, the characteristic amount content Ci of an i-th query is found as follows. That is, it is assumed that when q_ij matches with u_k for the above |Qi∩U|, w_k is added. This is a method in which when a word contained in the query characteristic amount matches with a word contained in the user's comment characteristic amount, a value weighted depending on the importance of the word is added instead of simply adding 1 per word.

FIG. 16 is an explanatory diagram illustrating a calculation result of an answer content of each question when word importance is added. The example illustrated in FIG. 16 indicates the answer contents when the word importance of “CHAIROI”=0.5, “SAIFU”=0.3, “NAKUSU”=0.3, “KOUBAN”=1.0, “IKU”=0.2, “MITSUKARU”=0.3 and “KOMARU”=0.5 is given, respectively. For example, in the example illustrated in FIG. 16, as a result of the addition of word importance, the characteristic amount content C3=0.6 of the ID1 query and the characteristic amount content C3=0.3 of the ID3 query are found. With the method, the characteristic amount content is higher as the words with higher word importance match, and thus an enhancement in accuracy can be expected.

Additionally, an answer content can be found with higher accuracy by use of previous knowledge for how to make the characteristic amount or how to measure the characteristic amount content.

For example, for making the characteristic amount, less characteristic words such as “ARU” (be) and “SURU” (do) are previously registered as stop words, and may be deleted from the characteristic amount.

For measuring a characteristic amount content, for example, the answer evaluation unit 141 extends the words contained in the query characteristic amount and the words contained in the user's comment characteristic amount to synonymous expressions thereby to make a consistency determination of words. In this case, if Japanese consistency is found in words, the words can be considered as the same. For example, it is assumed that the expression “MIATARANAI” (not be found) is made in the user's expression. In this case, consistency is not considered as being kept between the word “MIATARANAI” and the word “NAKUSU” (lose.) In such a case, however, the words converted into the synonymous expressions such as “NAKUSU” and “FUNSHITSUSURU” (lose) are added, thereby making a consistency determination with high accuracy.

The answer evaluation unit 141 may convert a query into information (such as predicted answer sentence pattern) which would be an answer for the query and may measure similarity between the converted information and the user's comment instead of directly measuring similarity (or characteristic amount content) between the characteristic words in the query and the user's comment. In the following, conversion of a query into information which would be an answer for the query will be simply denoted as query conversion.

The rules of the query conversion may be generated by use of a conversion table, for example. FIG. 17 is an explanatory diagram illustrating an exemplary conversion table. In the example illustrated in FIG. 17, one conversion rule is registered per record. In the example illustrated in FIG. 17, “:” indicates that the right and left elements across it are consecutive words, attribute values, or in a direct modifying/modified relationship. Further, in the example illustrated in FIG. 17, the inside in “[ ]” indicates an attribute value of a word. The attribute value of a word includes part of speech, root form, and conjugation, and further information on predetermined classification item as to whether the word indicates a person, a place or a time.

A number-given attribute value in “[ ]” indicates that an unconverted word is substituted into the H part with the same number after conversion. For example, when the character string “DONNASAIFU” (what kind of wallet) is present in a query, “SAIFU” (wallet) is a noun, and thus corresponds to a sequence of unconverted words or attribute values “DONNA: [noun 1]” (what kind of: [noun 1]) in the conversion rule of the rule No 2 in the conversion table. Therefore, information on the converted query “[adjective]: SAIFU” ([adjective]: wallet) can be acquired according to the sequence “[adjective]: [noun 1]” of converted words or attribute values in the conversion rule.

For example, in step S112 described above, each query is divided into words by a morphological analysis. At this time, the answer evaluation unit 141 may specify an attribute value of each word. Some morphological analyzers can output the kind of a unique expression corresponding to each word, and thus its function may be employed. Further, the answer evaluation unit 141 may assign an attribute value to each word by use of a database in which correspondences between words and attribute values are recorded.

In this way, converted information (such as predicted answer sentence pattern) can be acquired by an attribute value given to each word and the conversion table. FIG. 18 is an explanatory diagram illustrating exemplary converted queries. FIG. 18 indicates that an underlined part in an unconverted query corresponds to a conversion rule. For example, in the example illustrated in FIG. 18, the ID2 query corresponds to the conversion rule No 1 in FIG. 17 and the ID3 query corresponds to the conversion rule No 2 in FIG. 17. Therefore, the answer evaluation unit 141 performs the conversion processing indicated by each conversion rule, thereby acquiring the predicted answer sentence patterns “[time]” for the ID2 query and “[adjective]: SAIFU” for the ID3 query as converted information.

In the case of no correspondence, the answer evaluation unit 141 finds a direct characteristic amount content between the query and the user's comment, and may assume it as an answer content. When converted information is acquired, the answer evaluation unit 141 finds a characteristic amount content between the information on the converted query and the user's comment for the query in addition to the direct characteristic amount content between the query and the user's comment. Two or more answer contents are found for one question, and in this case, the answer evaluation unit 141 may employ the largest value.

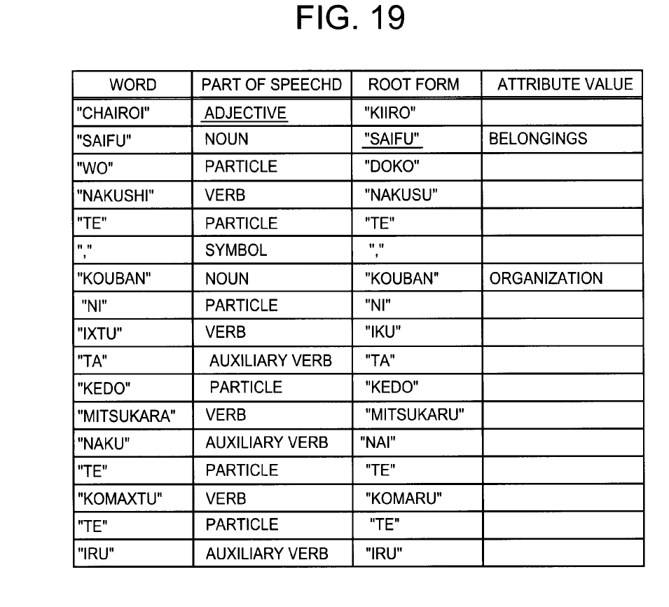

When a characteristic amount content between the information on a converted query and the user's comment is found, the answer evaluation unit 141 may make an attribute value estimation also for the user's comment. FIG. 19 is an explanatory diagram illustrating exemplary analysis results of a morphological analysis made on the user's comment and exemplary attribute value estimations. The exemplary attribute values indicated in FIG. 19 utilize the unique expression classification items, but available attribute values are not limited thereto.

The sequences of words or attribute values are dealt as converted information in the conversion table. Thus, also when finding a characteristic amount content between the information on a converted query and the user's comment, the answer evaluation unit 141 searches a sequence of words or attributes contained in the converted information without dealing with the words in a vector sequence.

For the ID3 query, a sequence of word and attribute value “[adjective]: SAIFU” is acquired as converted information. Therefore, the answer evaluation unit 141 confirms whether an adjective word is contained in the user's comment and the word “SAIFU” (wallet) follows the word or is directly modified. If a word meeting the condition is present in the user's comment, the answer evaluation unit 141 assumes that the word corresponds to a converted sequence, and assumes an answer content of the ID3 query at 1.0. By doing so, it can be determined with higher accuracy that a possible answer for the ID3 query “DONNASAIFUDESUKA?” (What kind of wallet is it?) is contained in the user's comment.

For the ID2 query, for example, a sequence of attribute value “[time]” is acquired as converted information. However, a word with the attribute value “time” is not present in the user's comment. Thus, it can be determined that a possible answer for the ID2 query “SAIGONIMITANOHAITSUDESHOUKA?” (When did you see it last?) is not contained in the user's comment.

Other exemplary attribute values include name of organization, name of person, name of location, expression of date, expression of time, expression of price, expression of rate and the like. The attribute values classified in more detail may be employed as attribute values. For example, the attribute values can be classified for a specialized field. The attribute values may be defined depending on dialog contents in the dialog system or an attribute value analysis capability.

The query ranking method by the query ranking unit 142 will be described below in more detail. The query ranking unit 142 calculates (1—answer content) per query as a question possibility in step S102 in FIG. 5, and may output a query with the highest question possibility as a query for the user's comment. When a plurality of queries with the highest question possibility are present, the query ranking unit 142 may randomly select and output one of them.

The query ranking unit 142 assumes, as a possibility, a value obtained by dividing each question possibility by a total sum of question possibilities of the queries contained in the set of queries, and may determine a query for the user's comment based on the possibility.

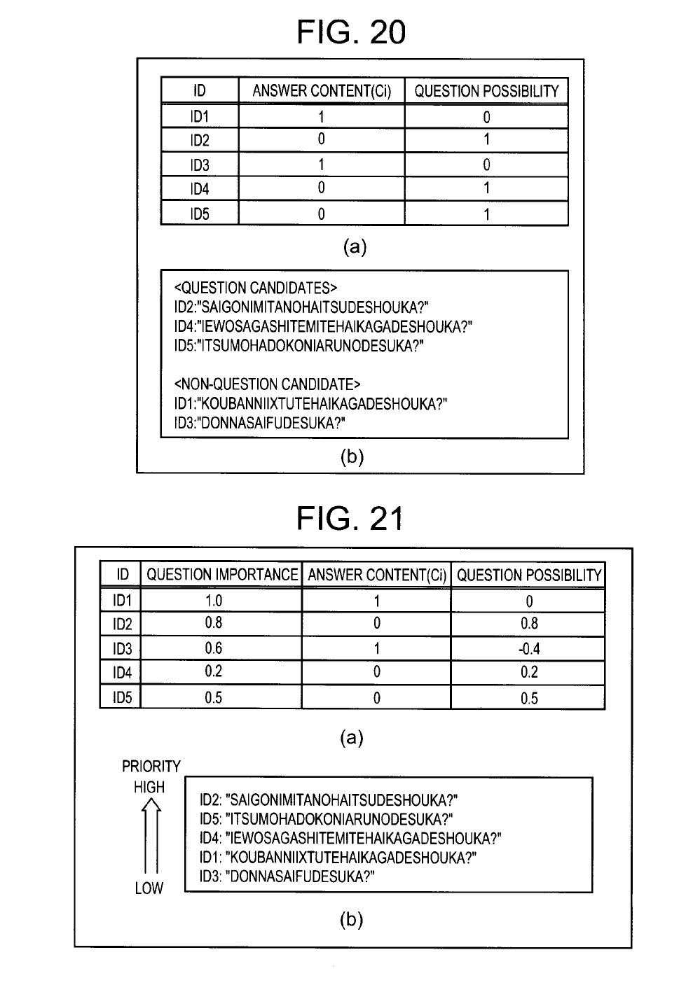

FIG. 20(a) is an explanatory diagram illustrating an example in which a question possibility of each query is calculated. FIG. 20(b) is an explanatory diagram illustrating an example in which each query is ranked based on a question possibility. In the example illustrated in FIGS. 20(a) and (b), a question possibility is found by (1—answer content), and each query is classified into a query as question candidate and a query as non-question candidate based on the found result. This is the same as two-step ranking.

In the example illustrated in FIGS. 20(a) and (b), the value of a question possibility takes only 0 or 1, and thus two classifications are employed. The query ranking unit 142 determines that a query with a question possibility of 0 or less is not assumed as a question candidate, and if the value is larger than 0, may output a query ranked depending on the value as a question candidate. A threshold as to whether a query is a question candidate may be held as a setting value in the system.

FIG. 21(a) is an explanatory diagram illustrating other exemplary calculations of question possibilities. FIG. 21(b) is an explanatory diagram illustrating an example in which each query is ranked based on its question possibility. In the example illustrated in FIGS. 21(a) and (b), a question possibility is found by (question importance-answer content), and each query with a higher question possibility is preferentially ranked as a question candidate based on the found result. In FIG. 21(b), the ID2 query has the highest priority.

In this way, if ranking is all performed in consideration of whether each query is appropriate based on an answer content of the query, and other factors, more appropriate queries can be ranked for a set of queries.

The example illustrated in FIG. 1 is an example in which a dialog function is automated by the response message generation unit 13, but a set of queries may be manually registered. This is applicable to question importance given to each query. That is, question importance may be manually given to each query. When the automatic dialog function is employed, confidence when a dialog can be established with a user's comment is generally quantified for the response message candidates, and thus the query ranking unit 142 may employ the value as question importance.

In the above description, there has been described the case in which a set of queries D12 is given to the redundant query removal unit 14, the queries contained in the set of queries are ranked based on their answer contents, and the result is output as the set of queries D12′. The ranking described herein includes removing a redundant query or selecting the best question.

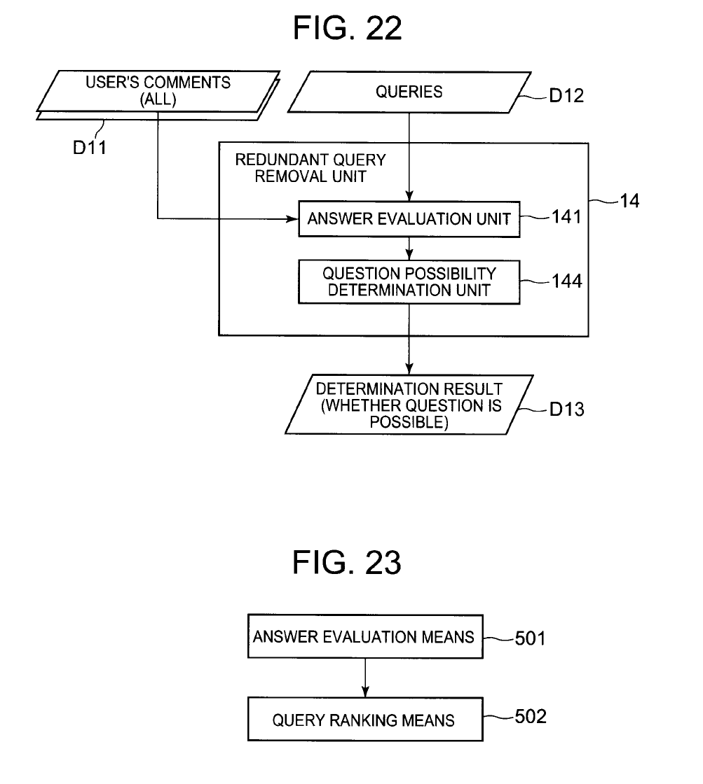

In the present exemplary embodiment, a plurality of queries may not be necessarily input into the redundant query removal unit 14. For example, as illustrated in FIG. 22, the redundant query removal unit 14 may be configured such that one query D12 is input therein and a determination result D13 as to whether the query can be a question candidate is returned each time. FIG. 22 is a block diagram illustrating other exemplary structure of the redundant query removal unit 14.

The redundant query removal unit 14 illustrated in FIG. 22 includes a question possibility determination unit 144 instead of the query ranking unit 142. The question possibility determination unit 144 calculates a question possibility without use of information on additional queries for an input query, and may determine whether the query can be a question candidate based on the calculated question possibility. The question possibility calculation method may be basically the same as the above method.

As described above, the dialog system according to the present exemplary embodiment determines, for a query to be output by the system, whether an answer for the question is contained in the input user's comment by use of an answer evaluation method for evaluating whether one set of sentences is in a question/answer relationship in terms of natural language processing. That is, the dialog system according to the present exemplary embodiment makes a characteristic amount selection based on feature information such as part of speech and combines matching processing by the selected characteristic amount with query ranking processing thereby removing redundancy of the question. Therefore, the characteristic amount does not need to be previously set per query by use of a partial character string database or the like, and thus the system can utilize many queries. Thus, also with the dialog system into which a variety of inputs are made, redundant queries can be prevented from being output by the system. Consequently, the user can smoothly have a dialog without losing a feeling of dialog.

According to the present exemplary embodiment, an answer content can be found without information as previous knowledge, and thus the system can prevent redundant queries from being output in a simple structure.

An outline of the present invention will be described below. FIG. 23 is a block diagram illustrating an outline of the present invention. The dialog system illustrated in FIG. 23 includes an answer evaluation means 501 and a query ranking means 502.

The answer evaluation means 501 (such as the answer evaluation unit 141) finds an answer content indicating how much an answer for each query is contained in a series user's comments for the query contained in a set of queries which are response message candidates for a user's comment as character string information indicating user's comment contents and which are character string information in a question form.

The query ranking means 502 (such as the query ranking unit 142 and the question possibility determination unit 144) ranks each query in ascending order of answer content based on the answer content of each query in the user's comment found by the answer evaluation means 501.

Any number of queries may be contained in a set of queries. For example, one query may be possible. The ranking performed by the query ranking means 502 includes classifying response message candidates into permitted and non-permitted irrespective of the number of queries.

The query ranking means 502 may remove a query with an answer content equal to or more than a predetermined threshold as a response message of redundant question from the response message candidates on ranking.

The query ranking means 502 may rank each query such that a query with a lower answer content is preferentially taken as a response message candidate.

The query ranking means 502 may rank each query based on importance of question given to each question and an answer content.

The answer evaluation means 501 may find confidence when each query and a user's comment is in a question/answer relationship and may find an answer content of the query in the user's comment based on the found confidence by use of an evaluation model for outputting and evaluating how much two arbitrary sentences are in a question/answer relationship as quantitative confidence.

The answer evaluation means 501 may find confidence when each query and a user's comment are in a question/answer relationship and may find an answer content of the query in the user's comment based on the found confidence by use of an evaluation model for outputting and evaluating how much two arbitrary sentences are in a question/answer relationship as quantitative confidence, the evaluation model in which when a characteristic word with predetermined part of speech contained in the two arbitrary sentences overlaps between the two sentences, confidence of a question/answer relationship is high.

The answer evaluation means 501 may include synonymous expressions in the characteristic words contained in the query and the user's comment and may determine whether a characteristic word overlaps between the two sentences when finding the confidence.

The answer evaluation means 501 includes a query conversion means for converting each query into a word/attribute sequence as information in which a sentence expression which would be an answer to the query is defined by a sequence of words or attribute values, and the answer evaluation means 501 may find confidence based on similarity between a word/attribute sequence converted from each query and a user's comment and may find an answer content of the query in the user's comment based on the found confidence by use of an evaluation model for outputting how much two arbitrary sentences are in a question/answer relationship as quantitative confidence, and for outputting confidence based on similarity between an arbitrary word/attribute sequence and an arbitrary sentence.

The present invention has been described above with reference to the exemplary embodiments and examples, but the present invention is not limited to the exemplary embodiments and examples. The structure or details of the present invention may be variously changed within the scope of the present invention understandable by those skilled in the art.

The present application claims the priority based on Japanese Patent Application No. 2011-258843 filed on Nov. 28, 2011, the disclosure of which is all incorporated herein by reference.

### INDUSTRIAL APPLICABILITY

The present invention is suitably applicable to any system capable of outputting a message in a question form to a sentence input by a calculator by use of natural language processing technique, not limited to a dialog system.

### REFERENCE SIGNS LIST

100 Dialog system
11 User's comment input unit
12 User's comment analysis unit
13 Response message generation unit
14 Redundant query removal unit
141 Answer evaluation unit
142 Query ranking unit
143 Query set update unit
144 Question possibility determination unit
15 Response message output unit
21 User's comment retaining unit
22 Dialog knowledge database
501 Answer evaluation means
502 Query ranking means

1. A dialog system comprising:
an answer evaluation unit that finds an answer content indicating how much an expression which would be an answer for a query is contained in a series of user's comments for each query contained in a set of queries which are response message candidates for a user's comment as character string information indicating user's comment contents and which are character string information in a question form; and
a query ranking unit that ranks each query in ascending order of answer content based on an answer content of each query in a user's comment found by the answer evaluation unit.

2. The dialog system according to claim 1,
wherein the query ranking unit removes a query with an answer content equal to or more than a predetermined threshold as a response message of redundant question from response message candidates.

3. The dialog system according to claim 1,
wherein query ranking unit preferentially ranks a query with a lower answer content as a response message candidate.

4. The dialog system according to claim 1,
wherein the query ranking unit ranks each query based on importance of question given to each query, and an answer content.

5. The dialog system according to claim 1,
wherein the answer evaluation unit finds confidence when each query and a user's comment are in a question/answer relationship and finds an answer content of the query in the user's comment based on the found confidence by use of an evaluation model for outputting how much two arbitrary sentences are in a question/answer relationship as quantitative confidence.

6. The dialog system according to claim 5,
wherein the answer evaluation unit finds a confidence when each query and a user's comment are in a question/answer relationship and finds an answer content of the query in the user's comment based on the found confidence by use of an evaluation model for outputting how much two arbitrary sentences are in a question/answer relationship as quantitative confidence, the evaluation model in which when a characteristic word with predetermined part of speech contained in each of the two sentences overlaps between the two arbitrary sentences, confidence in a question/answer relationship increases.

7. The dialog system according to claim 6,
wherein the answer evaluation unit contains synonymous expressions of characteristic words contained in a query and a user's comment in the characteristic words.

8. The dialog system according to claim 1,
wherein the answer evaluation unit includes a query conversion unit that converts each query into a word/attribute sequence which is information defining a sentence expression which would be an answer for the query by a sequence of words or attribute values, and
the answer evaluation unit finds confidence based on similarity between a word/attribute sequence converted from each query and a user's comment and finds an answer content of the query in the user's comment based on the found confidence by use of an evaluation model for outputting how much two arbitrary sentences are in a question/answer relationship as quantitative confidence and for outputting confidence based on similarity between an arbitrary word/attribute sequence and an arbitrary sentence.

9. A redundant message removal method comprising:
finding an answer content indicating how much an expression which would be an answer for a query is contained in a series of user's comments for each query contained in a set of queries which are response message candidates for a user's comment as character string information indicating user's comment contents and which are character string information in a question form; and
when the found answer content of the query in the user's comment is higher than a predetermined threshold, removing the query as a response message of redundant question from the response message candidates.

10. A non-transitory computer readable information recording medium storing a redundant message removal program that, when executed by a processor, performs a method for:
finding an answer content indicating how much an expression which would be an answer for a query is contained in a series of user's comments for each query contained in a set of queries which are response message candidates for a user's comment as character string information indicating user's comment contents and which are character string information in a question form; and
when the found answer content of the query in the user's comment is higher than a predetermined threshold, removing the query as a response message of redundant question from the response message candidates.

11. The dialog system according to claim 2,
wherein query ranking unit preferentially ranks a query with a lower answer content as a response message candidate.

12. The dialog system according to claim 2,
wherein the query ranking unit ranks each query based on importance of question given to each query, and an answer content.

13. The dialog system according to claim 3,
wherein the query ranking unit ranks each query based on importance of question given to each query, and an answer content.

14. The dialog system according to claim 2,
wherein the answer evaluation unit finds confidence when each query and a user's comment are in a question/answer relationship and finds an answer content of the query in the user's comment based on the found confidence by use of an evaluation model for outputting how much two arbitrary sentences are in a question/answer relationship as quantitative confidence.

15. The dialog system according to claim 3,
wherein the answer evaluation unit finds confidence when each query and a user's comment are in a question/answer relationship and finds an answer content of the query in the user's comment based on the found confidence by use of an evaluation model for outputting how much two arbitrary sentences are in a question/answer relationship as quantitative confidence.

16. The dialog system according to claim 4,
wherein the answer evaluation unit finds confidence when each query and a user's comment are in a question/answer relationship and finds an answer content of the query in the user's comment based on the found confidence by use of an evaluation model for outputting how much two arbitrary sentences are in a question/answer relationship as quantitative confidence.
